(19) United States
(12) Patent Application Publication
(10) Pub. No.: US 2012/0112416 A1
(43) Pub. Date: May 10, 2012

(54) MECHANICAL SEAL WITH FRICTION MONITORING DEVICE

(75) Inventors: Wolfgang Berger, Benediktbeuem (DE); Markus Bareis, Pflugdorf (DE)

(73) Assignee: EagleBurgmann Germany GmbH & Co., KG, Wolfratshausen (DE)

(21) Appl. No.: 13/377,177

(22) PCT Filed: May 10, 2010
(86) PCT No.: PCT/EP2010/002863

§ 371 Date: Jan. 30, 2012

(30) Foreign Application Priority Data
Jun. 10, 2009 (DE) 202009008089.7

(51) Int. Cl. F16J 15/34; G01L 1/22

(52) U.S. Cl. 277/358

(57) ABSTRACT

The invention refers to a mechanical seal, comprising at least one pair of interacting seal rings (3, 4), one of which is provided for a common rotation with a rotating component (2), and the other of which is retained at a stationary component (20) in a torque-proof manner against a rotation with the rotating component (2), and a monitoring device (6) for monitoring an operating state of the mechanical seal. The invention stands out in that the monitoring device (6) comprises a beam (7) including a sensor element for detecting a bending of the beam, in particular a strain gauge, wherein the beam (7) is arranged in a recess (14) in the stationary seal ring (4) and the beam (7) contacts a wall (14a) of the recess (14) in the stationary seal ring with a predetermined pretension, and further comprises an adjusting device in order to adjust a position of the beam (7) with respect to the recess (14).

The present invention relates to a mechanical seal comprising a monitoring device for monitoring an operating state of the mechanical seal.

Mechanical seals are known from the state of the art in different embodiments. During operation, friction forces occur between the seal rings of a mechanical seal. The intensity of the friction forces depends on whether the sliding surfaces contact each other or whether a lubricant film is existent between the sliding surfaces. The term “lubricant film” not only refers to a film of a fluid medium, but also to a gas film in case of gas-lubricated mechanical seals. In case the lubricant film is not sufficiently provided, friction forces can occur between the seal rings. The intensity of the friction forces substantially depends on whether the sliding surfaces of the seal rings contact each other. In many cases, a so-called mixed friction occurs, i.e. the lubricant film covers the sliding surfaces not completely or a ratio of solid state friction between the seal rings increases. For judging a tribological state at the sliding surfaces, it is thus required to sense the existing friction forces. The friction forces disclose a clear indication how large a ratio of solid state friction is.

From DE 20 2007 001 223.3 U, a monitoring device for a mechanical seal is known, which comprises a force detecting device provided in the rotational force closure between a stationary component and the rotating seal ring. Herein, the force detecting device is arranged at the stationary seal ring at a pressure-released portion behind a secondary seal. However, this known monitoring device features a relatively laborious and thus expensive structure.

It is therefore an object underlying the present invention to provide a mechanical seal which comprises a monitoring device which enables a determination of the friction torque directly at the stationary seal ring, while having a simple structure and being producible easily and at low costs.

This object is solved by a mechanical seal including the features of claim 1. The sub-claims show preferred further developments of the invention.

According to the invention, it is thus possible to directly determine the friction torque at the stationary seal ring. This enables a secure judgement of a tribological state at the sliding surfaces and thus e.g. enables that measures against an increased wear at the sliding surfaces can be started at an early stage. According to the invention, a monitoring device comprising a beam including a sensor element, in particular a strain gauge, is provided, wherein the sensor element can detect a bending of the beam. The beam is arranged in a recess in the stationary seal ring, wherein a position of the beam with respect to the recess can be changed and subsequently fixed by means of an adjusting device. The beam is arranged in the recess such that it contacts a wall of the recess in the stationary seal ring with a predetermined pretension. The predetermined pretension guarantees that the beam securely contacts the stationary seal ring, such that a bending of the beam occurs immediately upon occurrence of a friction between the seal rings of the mechanical seal, which can then be detected by the sensor element. The structure of the inventive monitoring device is very simple and cost-effective, and is further very compact. In addition, the monitoring device is arranged in an atmosphere region of the mechanical seal and therefore does not need to comprise any elaborate technical means against high pressures.

Preferably, the beam is arranged in a sensor housing such that the monitoring device can be provided as a separate module. Particularly preferred, the adjusting device comprises elongated hole recesses in the sensor housing for an adjustable fixation at a housing component of the mechanical seal.

It is further preferred, that the monitoring device comprises a display which is configured to display a position of the beam in the recess of the stationary seal ring with the predetermined pretension. The display is preferably an optical and/or acoustic display.

It is particularly preferred that the beam of the monitoring device is arranged in the recess in the radial direction of the stationary seal ring. Therewith, it is in particularly avoided that the use of the monitoring device results in a larger axial construction length of the mechanical seal. Further preferred, the sensor housing is also arranged at a radial outer side of the stationary seal ring.

According to a further preferred embodiment of the invention, the monitoring device further comprises a pin which is arranged at the beam and in the recess in the stationary seal ring. Consequently, a friction torque transmitted to the stationary seal ring is transmitted to the pin first and then to the beam. The pin is preferably press-fitted into the beam of the sensing device and is particularly preferably arranged in an angle of approx. 90° relative to the beam. It is particularly preferred that the pin is substantially arranged in an axial direction of the stationary seal ring.

In the following, preferred embodiments are described with reference to the accompanying drawing, in which:

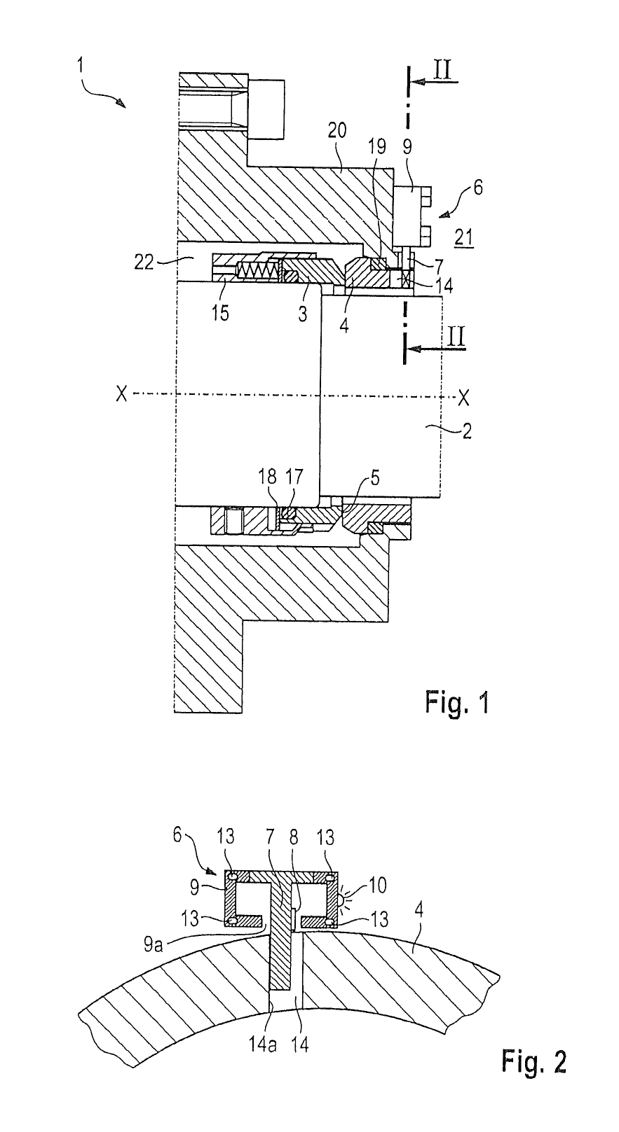

FIG. 1 shows a schematic sectional view of a mechanical seal according to a first embodiment of the invention,

FIG. 2 shows a schematic sectional view of the mechanical seal along line II-II of FIG. 1,

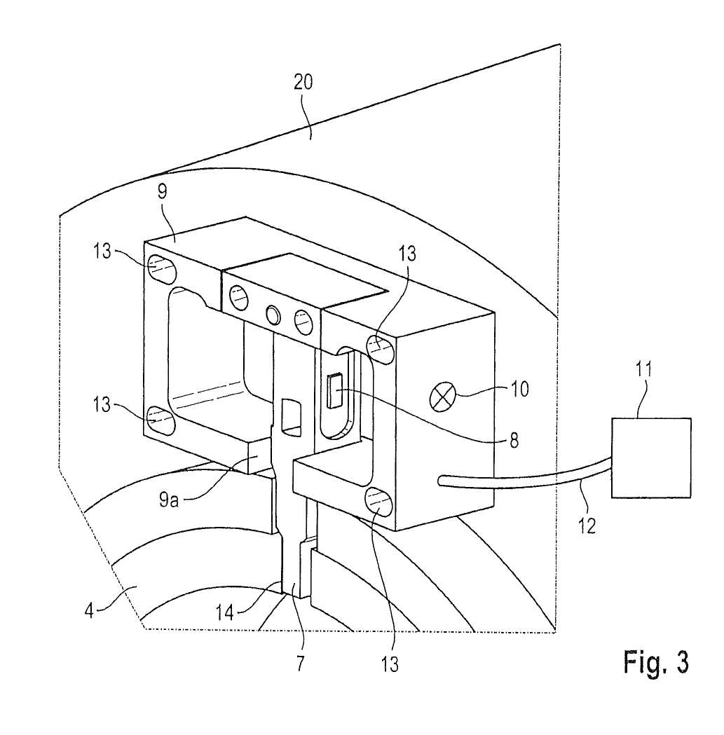

FIG. 3 shows a perspective view of a mechanical seal of the first embodiment, and

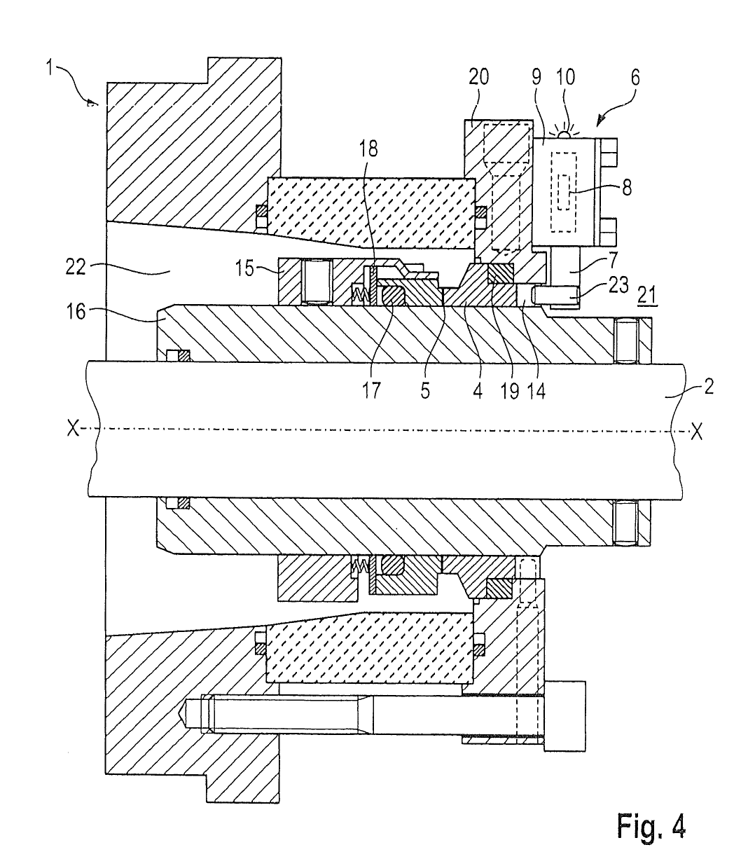

FIG. 4 shows a sectional view of a mechanical seal according to a second embodiment of the invention.

In the following, a mechanical seal 1 according to a first embodiment of the invention is described in detail with reference to FIGS. 1 to 3.

As is discernible from FIG. 1, the mechanical seal 1 comprises a shaft 2 as a rotating component, to which a rotating sleeve 15 is fixed. The sleeve 15 holds a rotating seal ring 3 such that same rotates together with the shaft 2. Further, the mechanical seal 1 comprises a stationary seal ring 4 which is arranged at a stationary component 20. A sealing gap 5 is provided between the rotating seal ring 3 and the stationary seal ring 4 in a known manner, in order to seal an atmosphere region 21 against a pressure region 22. An axial pretensioning force can be applied through an axial pretension ring 18 onto the rotating seal ring 3. O-rings 17 and 19 seal the seal rings against the shaft 2 and the stationary component.

The mechanical seal 1 further comprises a monitoring device 6 which is shown in detail in FIGS. 2 and 3. The monitoring device 6 comprises a beam 7 at which a sensor element in the form of a strain gauge 8 is arranged. The beam 7 is provided as a bending beam and the strain gauge 8 can detect a bending of the beam 7. The strain gauge 8 is connected to an evaluation unit 11 through a cable 12 (see FIG. 3). The monitoring device 6 further comprises a sensor housing 9 as well as a LED 10. As is discernible from FIG. 3, the sensor housing 9 is substantially shaped as a cuboid including a slot 9a, wherein the beam 7 extends through the slot 9a to the outside of the sensor housing 9. Herein, one end of the beam 7 is fixedly connected to the sensor housing 9. Further, the sensor housing 9 comprises four elongated holes 13 which are arranged at the corners of the sensor housing 9 and are part of an adjusting device. By means of stud bolts which are passed through the elongated holes 13, the sensor housing 9 can be adjustably attached at the stationary component 20. A change of position can be performed by means of the elongated holes 13 with respect to the stationary component 20. The monitoring device 6 is arranged in the atmosphere region 21 and is thus not subjected to high pressures.

As is particularly shown in FIG. 2, the beam 7 extends to the outside of the sensor housing 9 and is arranged in a recess 14 in the stationary seal ring 14. A free end of the beam 7 thus protrudes from the sensor housing 9. The arrangement of the beam 7 in the recess 14 is made such that the beam 7 contacts a wall 14a of the recess 14 with a predetermined pretension. The recess 14 in the stationary seal ring 4 is formed such that a clearance fit exists between the inserted beam 7 and the recess 14. The beam 7 is arranged in the recess 14 such that its longitudinal axis is arranged in the radial direction of the stationary seal ring 4.

The monitoring device 6 further comprises a display 10 in the form of a LED, which e.g. displays a correct strength of the pretension of the beam 7 due to the contact with the wall 14a of the recess 14 by two different colours (red and green). This facilitates in particular the assembly of the monitoring device 6, since the pretension of the beam 7 can be adjusted by aligning the sensor housing and thus the beam 7 with respect to the stationary component 20. In case the beam 7 is positioned with the correct pretension, the monitoring device is then screwed in the correct position to the stationary component 20 by means of screws.

In case that, due to parameter modifications during operation, a friction force at the sealing gap 5 is transmitted to the stationary seal ring 4, this friction force is directly transmitted to the beam 7 which serves as a bending beam fixed on one side and performs a bending of the beam 7. This bending can be detected by the strain gauge 8 and evaluated by the evaluation unit 11. It shall be noted that the beam 7 abuts at the wall 14a of the recess 14 with a pretension which lies in the rotating direction of the rotating seal ring 3. Consequently, an immediate reaction of the monitoring device upon occurrence of a friction force is secured.

According to the invention, it is thus possible to determine a load condition of the sliding pair very exactly due to the direct determination of the friction torque at the stationary seal ring 4. In particular, a clear indication can be obtained, how large a ratio of solid state friction and fluid friction of the mechanical seal 1 is, and respective counter-measures can be started at an early stage accordingly. Further, the stationary seal ring 4 is weakened only to a small extent by providing the recess 14 which has very small dimensions, such that the use of the monitoring device 6 does not have any negative influence on the operational behaviour of the stationary seal ring 4. The recess is arranged at an end of the stationary seal ring opposite to the sealing surface. Since the monitoring device 6 is further arranged in the radial direction of the stationary seal ring 4, it is prevented that an additional axial space in the mechanical seal 1 has to be provided due to the use of the monitoring device 6. Therewith, the mechanical seal 1 including the monitoring device 6 can show very compact dimensions in the direction of an axial axis X-X.

In the following, a mechanical seal 1 according to a second embodiment of the invention is described in detail, wherein identical parts or parts having the same function are designated with the same reference numerals as in the first embodiment.

The mechanical seal 1 of the second embodiment differs from the first embodiment by comprising a modified monitoring device 6. As is discernible from FIG. 4, the monitoring device 6 additionally comprises a pin 23 which is arranged at a free end of the beam 7. The pin 23 is arranged such that its longitudinal axis is aligned in parallel with the longitudinal axis X-X. Herein, the pin 23 engages with the recess 14 at the stationary seal ring 4 in an axial direction. As is shown in FIG. 4, the recess 14 is also directed in an axial direction. In the second embodiment, the monitoring device 6 is also located in the atmosphere region 21 such there result no problems occur in view of a pressure load on the monitoring device 6.

The pin 23 is arranged such that it abuts on at least one wall surface of the recess 14. The pin 23 is fixed in a recess in the beam 7 by means of a press-fit. Other ways of fixation of the pin 23 at the beam 7, e.g. screwing and/or gluing, are also possible. As in the first embodiment, a clearance fit is provided between the pin 23 and the recess 14 in the stationary seal ring 4. Apart from the above, this embodiment corresponds to the first embodiment such that reference can be made to the respective description.

1. A mechanical seal, comprising:
at least one pair of interacting seal rings, one of which is provided for a common rotation with a rotating component, and the other of which is retained at a stationary component in a torque-proof manner against a rotation with the rotating component, and
a monitoring device for monitoring an operating state of the mechanical seal, wherein
the monitoring device
comprises a beam including a sensor element for detecting a bending of the beam, in particular a strain gauge, wherein the beam is arranged in a recess in the stationary seal ring and the beam contacts a wall of the recess in the stationary seal ring with a predetermined pretension, and
further comprises an adjusting device in order to adjust a position of the beam with respect to the recess.

2. The mechanical seal of claim 1, wherein the beam is fixedly attached in a sensor housing and the adjusting device comprises elongated hole recesses provided in the sensor housing for adjustable fixation at a housing component.

3. The mechanical seal of claim 1, further comprising a display which is configured to display the achievement of the predetermined pretension when positioning the beam in the recess.

4. The mechanical seal of claim 3, wherein the display is an optical and/or acoustic display.

5. The mechanical seal of wherein, the beam is arranged in a radial direction in the recess of the stationary seal ring with respect to an axial axis (X-X) of the mechanical seal.

6. The mechanical seal of claim 2, wherein the sensor housing is arranged at a radial outside of the stationary seal ring.

7. The mechanical seal of claim 1, further comprising a pin arranged at the beam and arranged in the recess in the stationary seal ring.

8. The mechanical seal of claim 7, wherein the pin is arranged at an angle of approx. 90° relative to the beam and/or that the longitudinal axis of the pin is arranged substantially in parallel with the axial axis (X-X) of the mechanical seal.

9. The mechanical seal of claim 1, wherein the monitoring device is arranged in an atmosphere region.

10. A mechanical seal assembly for a gaseous medium, comprising a mechanical seal according to claim 1.
